(19) United States
(12) Patent Application Publication
(10) Pub. No.: US 2012/0179359 A1
(43) Pub. Date: Jul. 12, 2012

(54) Methods and Apparatus for Navigation Including Vehicle Recharging

(75) Inventors: Elizabeth Profitt-Brown, Plymouth, MI (US); Kelly Lee Zechel, Plymouth, MI (US); Joseph Paul Rork, Canton, MI (US); Brian Petersen, Ferndale, MI (US); Edward Andrew Pleet, Livonia, MI (US)

(73) Assignee: FORD GLOBAL TECHNOLOGIES, LLC, Dearborn, MI (US)

(21) Appl. No.: 12/985,509

(22) Filed: Jan. 6, 2011

(51) Int. Cl. G06F 19/00

(52) U.S. Cl. 701/123

(57) ABSTRACT

A computer-implemented method includes determining the reachability of one or more known refueling points along a route-to-be-traveled. The method also includes selecting one or more recommended refueling points, based at least in part on the determined reachability of the one or more known refueling points. The method further includes outputting at least a portion of the route-to-be-traveled including at least one recommended refueling point and providing an option to route a vehicle to the recommended refueling point. The method additionally includes, responsive to a selection of an option to route the vehicle to the recommended refueling point, providing a route from a present destination to the recommended refueling point, wherein, when the recommended refueling point has been reached, the route reverts to the route-to-be-traveled.

### TECHNICAL FIELD

The illustrative embodiments generally relate to methods and apparatus for navigation including vehicle recharging.

### BACKGROUND

The advent of electric powered vehicles (EVs, generally), including, but not limited to, battery electric vehicles, hybrid electric vehicles, plug-in hybrid electric vehicles, etc., has generated a fair amount of interest in the driving community for the use of these vehicles as alternatives to traditional gasoline powered vehicles.

These vehicles, however, unlike traditionally powered vehicles, run either on pure electricity or a mix of electricity and gasoline. One advantage of many of these vehicles is that they can be charged at a home location, that is, they can be plugged into a wall socket similar to, say, a rechargeable battery. Although this charging may take longer than at a charging station (designed to swiftly recharge a vehicle), it is a viable option for “fueling” a vehicle without leaving the comfort of home.

Often times, however, much as with gasoline powered vehicles, drivers will wish to embark on journeys that entail more than one full complement of fuel (be it electricity, gasoline, or a mix of both). In instances such as this, unless a home or other usable non-commercial location is available along the route, before fuel is fully consumed, a user will need to take advantage of a commercial refueling station.

Due to the fact that EVs have only recently become available, there are a limited number of stations for refueling, as compared to traditional gas stations. While a user traveling down a highway can typically find gasoline at a minimum of every few exits, a user employing an EV, especially a purely electric powered EV, must be careful not to run out of fuel.

### SUMMARY

In a first illustrative embodiment, a computer-implemented method executable by a vehicle associated computing system (VACS) includes determining the reachability of one or more known refueling points along a route-to-be-traveled. The exemplary method also includes selecting one or more recommended refueling points, based at least in part on the determined reachability of the one or more known refueling points.

The illustrative method further includes outputting at least a portion of the route-to-be-traveled including at least one recommended refueling point and providing an option to route a vehicle to the recommended refueling point.

The illustrative method additionally includes, responsive to a selection of an option to route the vehicle to the recommended refueling point, providing a route from a present destination to the recommended refueling point, wherein, when the recommended refueling point has been reached, the route reverts to the route-to-be-traveled.

In a second illustrative embodiment, a computer-readable storage medium stores instructions that, when executed by a vehicle associated computing system (VACS), cause the VACS to perform the method including determining the reachability of one or more known refueling points along a route-to-be-traveled. The illustrative method further includes selecting one or more recommended refueling points, based at least in part on the determined reachability of the one or more known refueling points.

The exemplary method additionally includes outputting at least a portion of the route-to-be-traveled including at least one recommended refueling point and providing an option to route a vehicle to the recommended refueling point.

The illustrative method further includes, responsive to a selection of an option to route the vehicle to the recommended refueling point, providing a route from a present destination to the recommended refueling point, wherein, when the recommended refueling point has been reached, the route reverts to the route-to-be-traveled.

In a third illustrative embodiment, a vehicle associated computing system (VACS) includes a processor, operable to determine the reachability of one or more known refueling points along a route-to-be-traveled based on logic present in a memory associated with the VACS. In this embodiment, the processor is operable to select one or more recommended refueling points, based at least in part on the determined reachability of the one or more known refueling points, based on logic present in the memory.

The illustrative system also includes a display in communication with the processor, operable to output at least a portion of the route-to-be-traveled including at least one recommended refueling point, based on instructions received from the processor. In this embodiment the display is further operable to provide an option to route a vehicle to the recommended refueling point, based on instructions received from the processor.

Also in this embodiment, the processor, responsive to a selection of an option to route the vehicle to the recommended refueling point, is operable to provide a route from a present destination to the recommended refueling point, based on logic stored in the memory. When the recommended refueling point has been reached, the processor is further operable to revert the route to the route-to-be-traveled, based on logic stored in the memory.

### BRIEF DESCRIPTION OF THE DRAWINGS

FIG. 1 shows an illustrative example of a vehicle associated computing system;

FIG. 2 shows an illustrative embodiment of a process for displaying one or more recommended charging points along a route;

FIG. 3 shows an illustrative embodiment of a process for evaluating the suitability of a charging point for display;

FIG. 4 shows an illustrative embodiment of a further process for evaluating the suitability of a charging point for display;

FIG. 5 shows an illustrative embodiment of a process for refueling point selection optimization;

FIG. 6 shows an illustrative example of a fuel point proximity driver assistance process;

FIG. 7 shows an illustrative example of a warning process for potential out-of-fuel conditions; and

FIG. 8 shows an illustrative example of a feasibility-of-route process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

When setting forth on a trip in a conventionally fueled vehicle, a driver typically will simply need to ensure that they don't allow a fuel gauge to dip below a certain level before refueling. Since gas stations are relatively prolific, as long as a user keeps the fuel gauge above a certain level, they can be generally assured that they will be able to obtain additional fuel if needed, prior to exhausting their fuel supply.

In EVs, however, especially in purely electrically powered EVs, a user may travel several hundred miles without finding a suitable refueling point. This could be, for example, because the user is unaware that an EV refueling point has been passed, or because the user is simply traveling in an area in which no known EV refueling stations exist. However, it could be quite inconvenient to embark on a trip of 400 miles, when your vehicle has a maximum range of 300 miles and no refueling stations exist along your route.

The illustrative embodiments presented herein can be used for route planning, and it is also possible that they are used throughout the course of a journey, when, in certain instances, projections may change based on changing data (such as, but not limited to, unexpected detours, stops, weather, traffic, etc.).

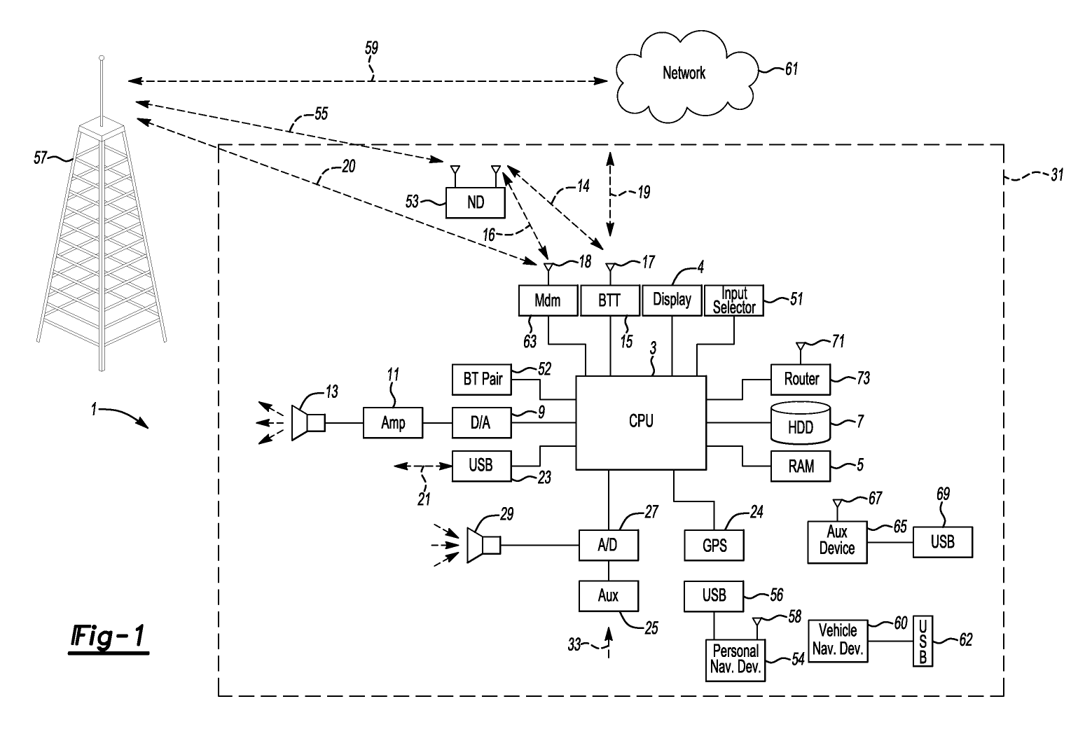

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen.

In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73. Auxiliary device 65 may include, but are not limited to, personal media players, wireless health devices, portable computers, and the like.

Although the following describes the invention in terms of illustrative embodiments, these examples are provided for non-limiting illustrative purposes only, and are not intended to limit the scope of the invention thereto.

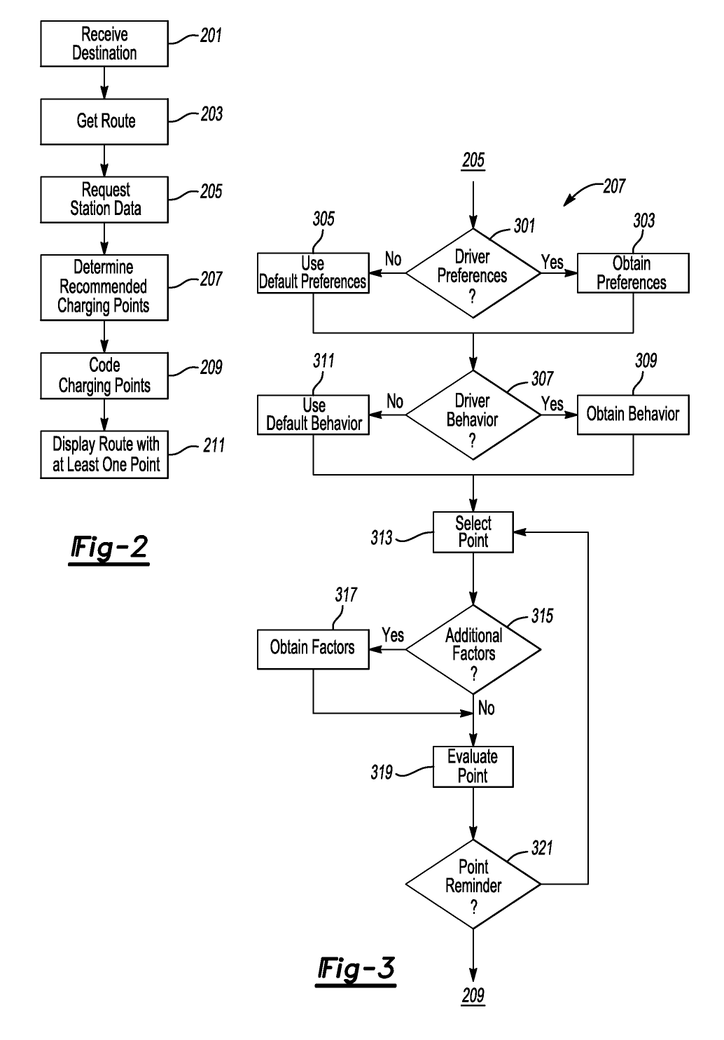

FIG. 2 shows an illustrative embodiment of a process for displaying one or more recommended charging points along a route. In this illustrative embodiment, a vehicle computing system (or a routing system such as, but not limited to, a wireless phone or a remote network, which may be capable of communication with a vehicle computing system) (collectively “a routing system”) receives a desired destination input 201. Then using an input indicating the current starting location, or using the GPS coordinates of the vehicle obtained from a vehicle located (in-vehicle or in communication with a vehicle computing system and located at the location of the vehicle) GPS system, the routing system calculates, or obtains, a vehicle route 203.

Once the vehicle route is obtained, the routing system may request station data 205. This data may be stored locally, in a database for example, or may be stored at a remote location and accessible by the routing system. In at least one embodiment, the station data includes a location of the station. In at least a second illustrative embodiment, the station data also includes the hours of operation of the station.

Next, in this embodiment, the vehicle computing system determines recommended charging points 207. Non-limiting examples of this determination process are discussed in conjunction with FIGS. 3-5. Generally, however, the system will select points that are reasonably close to a route and that do not allow a vehicle to run out of fuel (projectedly speaking) before reaching them.

In this illustrative embodiment, the vehicle computing system may also “code” the charging points 209. For example, points that should be well within a vehicle's fuel capability to reach may be designated in one manner, and points that are questionable may be designated in another manner, and points that are likely unreachable may be designated in still another manner. Similarly, other features, including, but not limited to, preferred brands, pricing, etc. may be coded (such that the representation of a point, or a screen associated with a point, may vary in appearance due to the coding).

Finally, in this illustrative embodiment, the system displays some or all of the route to be traveled 211. In this particular embodiment, the system displays at least a portion of the route including a charging station (although the display may not be fixedly displayed in this manner, the system shows the user where at least a first charging station along the route occurs). This may be useful if, for example, the first station along the route is coded as “questionable”, and may cause, for example, a user to fully or more completely fuel a vehicle before embarking. Of course, it is also possible to simply display (or otherwise output) a shorter or longer portion of the route to be traveled.

FIG. 3 shows an illustrative embodiment of a process for evaluating the suitability of a charging point for display. In this illustrative example, a routing system has received some portion of the requested station data 205 and is determining the suitability of various points along a route. In this illustrative example, the routing system first determines if there are any preset driver preferences to be associated with a routing request 301. These preferences may be stored locally or remotely from the routing system, and may include, but are not limited, such items as preferred minimum fuel level, EV power only if available, preferred proximity to route, etc. A preferred minimum fuel level may be a level below which the driver does not wish to extend, if avoidable. An EV power only if available setting may instruct a routing system to find stations such that, in a vehicle that uses both gasoline and electricity, electricity only is used, unless impossible due to station location. A preferred proximity to route setting may set a maximum distance, time, fuel usage, etc. for deviances from a main route to fueling points. These preferences can also be input at the time of the route request, and are not limited to the examples discussed above.

If preferences exist (or are input), the routing engine may obtain them for use in station suitability determinations 303. If there are not preferences, or if the user selects default preferences, then a series of default (for example, but not limited to, OEM preset) preferences may be used 305. Of course, it may also be possible to make the suitability determination without resorting to default or preset preferences for a vehicle.

In at least one embodiment, not shown, vehicle data is also obtained, such that a current vehicle fuel level is considered when addressing the suitability of points along a route. This can be considered in numerous factors.

For example, without limitation, if a current level is at 80%, the route may be determined such that stops are limited to thirty minute stops (based on, for example, without limitation, a driver preference). If sufficient refueling stations exist, it might be possible plan out a route such that refueling stations are only visited such that battery power, by the end of the trip, is minimized (to an acceptable low level), and stations are only visited as frequently as needed to ensure that the final low level is not likely to be undershot.

In another illustrative example, a driver may wish to stop for a meal (this could be, for example, an input preference). In this example, the driver could indicate an approximate time of day (or point of trip) at which food is likely to be desired. The driver may also indicate how long they are likely to stop for food, and the system can determine how much charge can be obtained in that time, and then calculate what other stops are needed. For example, if a driver likes to take a break of an hour for a meal, but only wishes to stop no more than thirty minutes at other points, the system can calculate either an optimal point for a meal or a route based on a desired stopping point or time. In instances such as this, but not limited to these instances, it may be useful to know the approximate or exact fuel level of the vehicle (as well as maximum fuel level).

Other factors that may be taken into general consideration include, but are not limited to, fuel specs for a vehicle (such as approximate efficiency, and approximate efficiency along the type of roads on which the vehicle is projected to be traveling). These may be included in the “preferences” or may be input by a driver (either directly or by inputting vehicle specs, make, model, age of vehicle, etc.), alternatively, they may be obtained by communication with the actual vehicle itself.

In this illustrative embodiment, another illustrative consideration that may be taken into account is driving behavior of a specific driver 307. If driving behavior is unknown or not available, then the system may use default OEM specs 311, for example. These specs may be, but are not limited to, typical fuel usage estimates for a particular vehicle on certain road types, under certain weather conditions, etc.

Alternatively, in this embodiment, driving behavior may be stored with respect to a given driver, and typical true fuel usage for that driver may be known and retrieved from storage (remote or local) or input by a driver 309.

The vehicle computing system may then select a point (corresponding to a refueling station) for a reachability consideration 313. Essentially, the reachability consideration is a determination of whether or not a vehicle will have sufficient fuel to travel to the station, and may also include additional factors such as, but not limited to, how much fuel will remain, whether a different station is optimal, etc.

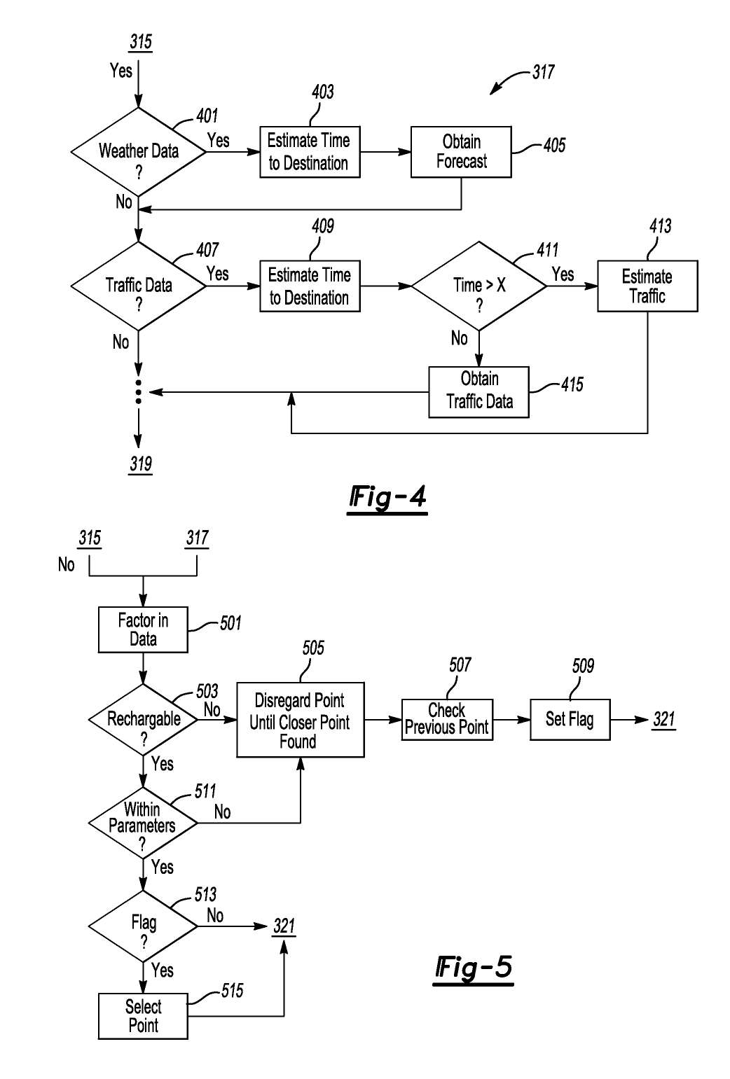

In this illustrative embodiment, prior to evaluation of a point for reachability, the routing system may determine if there are any additional factors to be considered 315. These factors are discussed in exemplary, non-limiting detail with respect to FIG. 4. If additional factors exist, then the system obtains these factors 317 (automatically or through input) and then proceeds with evaluation of the particular point 319. If no points remain for evaluation, the process moves to step 209, otherwise the evaluation process continues 313.

FIG. 4 shows an illustrative embodiment of a further process for evaluating the suitability of a charging point for display. In this illustrative embodiment, just a few factors, of the many possible factors to consider, are shown for exemplary purposes. These are factors that, in this example, are germane to travel to a particular location from a previous location. For example, without limitation, they may be considered for travel from a starting point to a first point, from a first point to a second point, or between any two points in a journey.

In this illustrative embodiment, the routing system checks to see if weather data is to be considered 401. Since weather can affect the fuel efficiency of an EV, due to such factors as slowing traffic and/or battery efficiency, to name a few, it may be desirable to obtain/use weather data in determining the reachability of a point. If weather data is to be used, in this embodiment, the system checks the estimated time (or distance) to a destination 403.

Using that data, the system may then check a forecast for the weather along the route. For example, if a destination point is two hours hence, it may not be reasonable to use the weather currently present near the destination for evaluation purposes 405. Instead, the system may use a projection of what the supposed weather will be as a vehicle approaches a point. In one embodiment, an iterative approach can be used to sample forecast data along a route (for example, without limitation, check the weather now for the first thirty minutes of a route, check the forecast for thirty minutes for portions of the route thirty minutes to an hour away, etc.). Other suitable methods of estimating weather conditions may also be implemented within the scope of the invention.

Similarly, if the user is planning a trip for a different time period than in the immediate future, this data can be fed to the routing system and weather projections can be considered (and possibly re-considered at the actual time of the trip).

If weather data is not to be used, or has been obtained, in this embodiment, traffic data may also be considered 407. If the traffic data is considered, then, in this embodiment, the system again estimates the amount of time required to reach the destination 409. If the time is greater than a predetermined time 411, then traffic data may be estimated 413 (or simply ignored until the destination is closer). If the destination is likely reachable within a certain period of time (or distance) the system may elect to obtain present traffic data 415 that may be relevant due to proximity. Other suitable factors that may affect the leg of a journey (or the whole journey) may also be considered in evaluating the reachability of a particular point.

FIG. 5 shows an illustrative embodiment of a process for refueling point selection optimization. In this illustrative embodiment, a routing system evaluates a point to optimize the point according to one or more preset conditions (which may be as simple as—can a standard vehicle with X amount of fuel operating under standard conditions reach this point) and/or driver preferences.

In this illustrative example, any conditions, such as, but not limited to, those previously mentioned herein are factored (if any exist) into an estimated fuel consumption consideration 501. Once the factors have been suitably treated and considered, it should be possible to know whether or not the vehicle is estimated to reach a particular point 503. If the furthest point is not likely reachable based on the “all factors considered” determination 501, the system may disregard that point (for purposes of this particular consideration) 505.

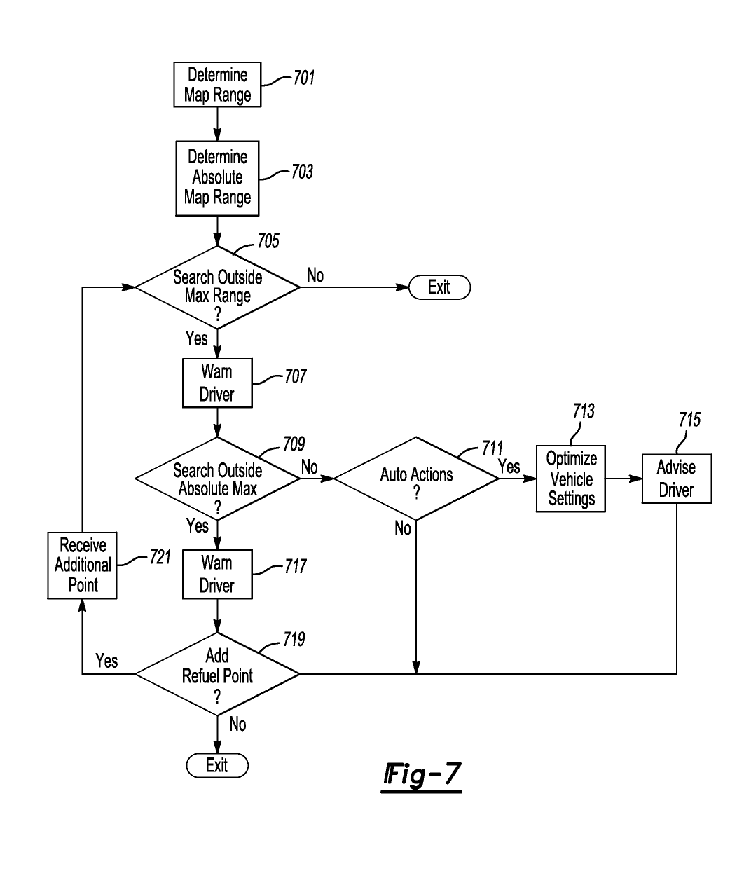

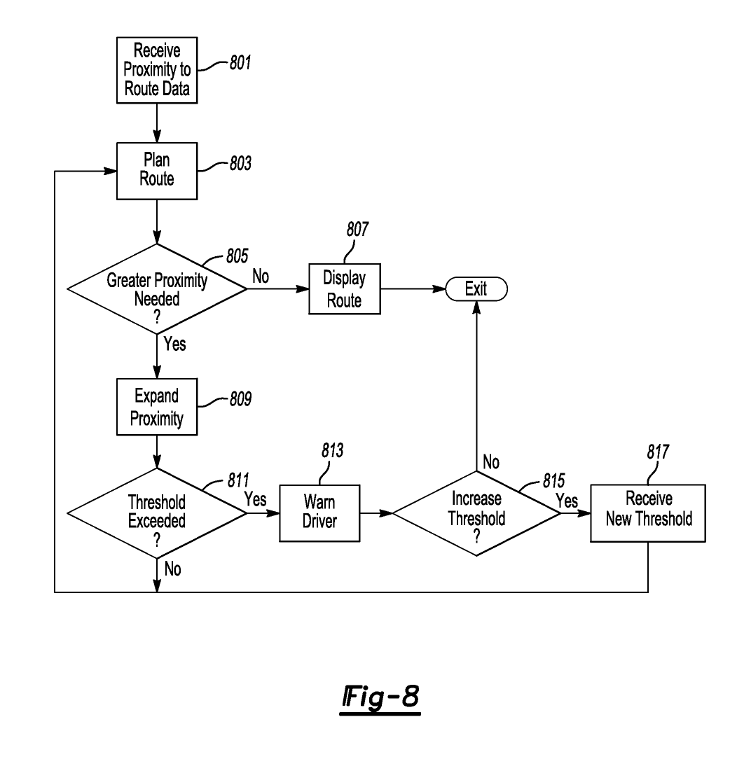

In this illustrative example, the system may select a furthest possible point (corresponding to a fuel station). This “furthest point” can be based on a variety of suitable factors. In one non-limiting example, it may be based on a maximum charge and maximum efficiency. In another non-limiting example it may be based on current charge and known efficiency. Any combination of suitable factors for determining point selection may be used. (Other algorithms, such as, but not limited to, nearest point consideration, may also be optionally employed). In another example, the system may simply determine the furthest the vehicle is likely to be able to travel geographically, and then request data for the station closest to, but not past, that point 505 and a “previous” (e.g., more proximate to the vehicle's route inception point) point may be considered 507. Of course, if no previous point exists, the system may warn the driver or adjust certain route-determination factors, as discussed in more detail in non-limiting examples shown in FIGS. 7 and 8.

The system then sets a flag, in this embodiment, effectively indicating that the point just before a non-reachable point is being considered and proceeds to step 321.

If the exemplary process results in a determination that a point is reachable 503, the system may then check to see if the point falls within other parameters that may need to be considered 511. For example, without limitation, the system may check to ensure that a projected stop is not estimated to be prolonged beyond a certain time (based on, for example, all stops projected along a route), or any other suitable factors. Alternatively, these secondary considerations may simply be integrated into step 501. If the stop is not within the secondary considerations, then the system proceeds to look for a closer point 505.

If the point is reachable, within parameters, and a flag has been set 513, then the system may determine that a point is suitable and select that point as a recommended stop 515. If the flag has not been set, then, while all parameters have been met, it may mean that the point is not the “true maximum” point, and the system will proceed to select a next point and evaluate that point.

This is just one non-limiting example of point consideration. Many possible alternatives exist, and suitable algorithms based on a variety of factors can be implemented such that the route selection is efficient and meets any pre-specified conditions. For example, without limitation, a driver may wish to stop every hour, and may request a route that most closely meets this requirement. In an instance such as this, a different algorithm may be used, or the reachability or secondary considerations (if used) may incorporate this request into a suitability determination.

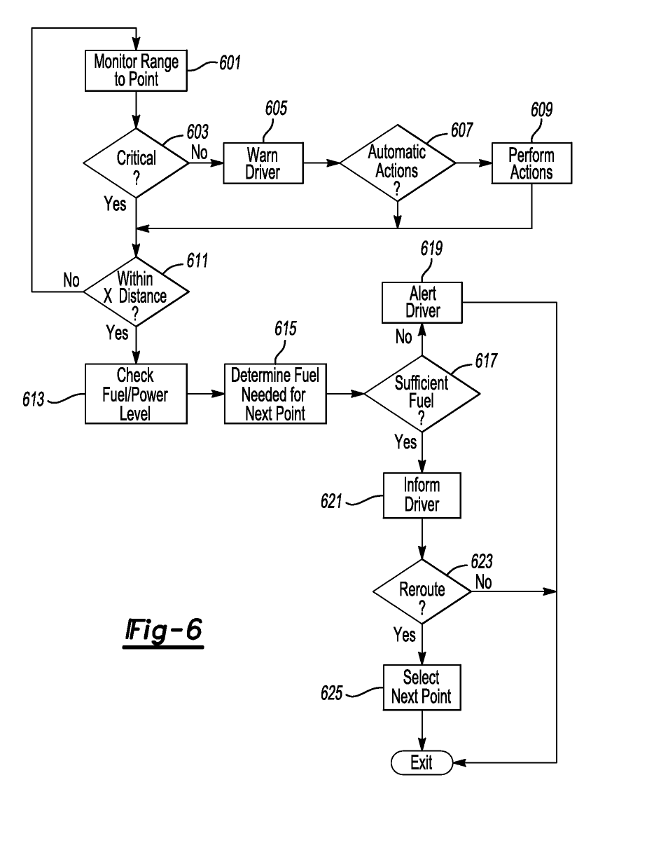

FIG. 6 shows an illustrative example of a fuel point proximity driver assistance process. In this illustrative example, the process may be executed in the background of a vehicle computing system or a computing system (such as, but not limited to, a wireless device or remote server) in communication with a vehicle computing system.

In this illustrative embodiment, the computing system (vehicular or otherwise) monitors a range between a driver and a refueling point 601. If at any point the likelihood of the driver reaching the point becomes critical (e.g., too little fuel or close to too little fuel remains) 603, the computing system may cause an alert to be indicated to the driver 605. This may help the driver to enact more efficient driving methods to preserve fuel, and/or may encourage the driver to disable ancillary accessories that may be draining fuel.

In this embodiment, the computing system also provides the driver the option to have automatic actions taken 607. If the driver opts for these actions, then the computing system may cause or request that the vehicle shut down some or all unnecessary sources of power. Additionally or alternatively, other actions may include, but are not limited to, speed limiting (or speed warning), eco-routing (suggesting a more fuel efficient route), etc. In another illustrative embodiment, the system may simply find a closer fuel station (if one exists).

If the driver is not at a critical point, the exemplary process checks to see if the recommended refueling station (point) is within a predetermined distance. If it is not, the system continues monitoring for proximity and/or criticality (these can provided as separate solutions, in the alternative).

If the vehicle is within a predetermined distance from the refueling station, the computing system checks the current fuel level 613. The system then determines how much fuel is needed to reach a next known point (incorporating any needed parameters) 615. If there is sufficient fuel (and any other considerations are appropriately met) 617, the system may inform the driver that a stop is not required 621, and ask if rerouting to a next station is desired 623.

If the driver desires rerouting, a next refueling station route may be provided 625. If there is insufficient fuel to reach the next known station, in this embodiment, the driver may be notified by the computing system that a stop is upcoming and it is highly recommended (or critical, etc.) that the driver stop to obtain fuel 619.

In addition to monitoring for proximity, it may be possible to monitor stations for refueling availability (or other considerations). If an estimated wait time (or simple charger availability is knowable), then the system may inform the driver of the possibility of continued travel if the other considerations are met.

FIG. 7 shows an illustrative example of a warning process for potential out-of-fuel conditions. In this illustrative embodiment, a routing system determines (or is provided with) a maximum range 701 and an absolute maximum range 703 (one range may be all that is needed, but in this example a “maximum range” corresponds to an average maximum and an “absolute maximum” corresponds to a range beyond the average incorporating any relevant conditions—e.g., without limitation, optimal fuel usage, current weather conditions, minimal (or current) traffic, etc.). In this embodiment, for each stretch of a route between refueling points, the computing system determines if the stretch of route is outside a maximum range 705. Another non-limiting alternative to implementing such an example would simply be in the instances where a suitable refueling point cannot be found along a route. If the current stretch is acceptable, the process exits.

If the stretch of route is outside the maximum range, the computing system may indicate to the driver that there is not a likely fuel point available for that portion of the journey 707. If the stretch of route is outside the absolute maximum range, the system may warn the driver 717 that even under optimal conditions there is not a likely fuel point 717 and ask the driver if they would manually like to add a fuel point 719. If the driver adds an additional point 721, the calculation can be performed again to determine the point's acceptability.

If the route is outside the maximum range, but not outside the absolute maximum range, the system may ask the driver if automatic actions should be performed to maximize fuel efficiency 711. If the driver opts to have these actions performed, the system can instruct the vehicle or otherwise indicate to the vehicle that optimal settings should be used 713. The driver may additionally be advised of what these settings entail (e.g., without limitation, if the “optimal settings” include no use of the HVAC system, and it is sub-freezing, the driver may simply elect to use a different vehicle, forego the trip, find a refueling alternative along the stretch, etc.).

The driver, in this embodiment, is again given the option to add a refueling point, and if no point is added, the process exits. Suitable action may be taken upon exit of the process with a dubious or projectedly impossible stretch of route, including, but not limited to, additional warnings, indication of that stretch of route as “likely impassible”, etc.

FIG. 8 shows an illustrative example of a feasibility-of-route process. In this illustrative embodiment, the system determines how much extra travel is projected to reach suggested refueling points. Since electrical refueling stations may be limited, a “four hour” trip in a gasoline powered vehicle, which may only require brief detours for fuel, may become undesirable in an EV due to the relative distance of refueling stations from a route.

In this embodiment, the system has or receives a proximity setting for purposes of an initial feasibility determination 801. For example, without limitation, an initial setting may be ten miles from a planned route. The system then proceeds with planning the route as previously discussed herein, determining suitable fuel stops. If, during the planning, a stretch of route does not appear to have a refueling station within a particular proximity designation, a greater proximity setting may be needed 805.

In this embodiment, the system expands the proximity 809 and determines if a threshold is exceeded 811 (alternatively or additionally the system could ask if the proximity should be expanded). If the threshold, which may be preset or driver input is not exceeded, the system rechecks the route with the new expanded proximity. If the proximity is exceeded 811, the system may warn the driver that at least a portion of the route has no refueling stations within the threshold proximity 813, and may ask the driver if an expanded threshold is desired 815. If no expanded threshold is desired, the system may exit (and take suitable action, such as, but not limited to, warning the driver, marking the “fuel unavailable” portions of the route, etc.). If a new threshold is input 817, the system may continue calculations increasing the proximity until the new threshold is met or all points along a route are obtained.

In one or more of the embodiments implemented with relation to the aspects of the present invention described in exemplary fashion with respect to, for example, without limitation, FIGS. 7 and 8, the unavailability of refueling stations may be a result of the consideration of other driver preferences if they are included in these considerations. In such cases, it is, of course, possible to ask the driver if other considerations should be changed. So, for example, in one non-limiting embodiment, a fuel station may be “unavailable” because the driver never wishes to go below 20% fuel. But instead of expanding a threshold, the driver may be asked if this preference can be changed. Such alternatives are considered to be within the scope of the present invention.

Although various processes, methods and systems are described herein, they are intended to be exemplary and non-limiting in manner. Sub-portions of the processes and suitable alternative algorithms may be implemented to produce the desired results as disclosed herein, and are considered to be within the scope of the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method executable by a vehicle associated computing system (VACS) comprising:
determining the reachability of one or more known refueling points along a route-to-be-traveled;
selecting one or more recommended refueling points, based at least in part on the determined reachability of the one or more known refueling points;
outputting at least a portion of the route-to-be-traveled including at least one recommended refueling point;
providing an option to route a vehicle to the recommended refueling point; and
responsive to a selection of an option to route the vehicle to the recommended refueling point, providing a route from a present destination to the recommended refueling point, wherein, when the recommended refueling point has been reached, the route reverts to the route-to-be-traveled.

2. The method of claim 1, wherein the using a vehicle associated computing system (VACS) to determine the reachability further comprises determining a current vehicle fuel level.

3. The method of claim 2, wherein the determining a current vehicle fuel level further comprises receiving input corresponding to a current vehicle fuel level.

4. The method of claim 2, wherein the receiving input further comprises communicating with a vehicle system capable of providing current fuel level data.

5. The method of claim 1, wherein the using a vehicle associated computing system (VACS) to determine the reachability further comprises determining a vehicle model.

6. The method of claim 5, wherein the determining a vehicle model further comprises receiving input corresponding to a vehicle model.

7. The method of claim 5, wherein the receiving input further comprises communicating with a vehicle system capable of providing vehicle model data.

8. The method of claim 1, wherein the using a VACS to select one or more recommended refueling points further comprises considering one or more driver trip preferences.

9. The method of claim 8, wherein the one or more driver trip preferences include a minimum fuel level threshold.

10. The method of claim 8, wherein the one or more driver trip preferences include a proximity of the refueling point to the route-to-be-traveled.

11. The method of claim 8, wherein the one or more driver trip preferences include limiting power use to electric power in a hybrid electric vehicle.

12. The method of claim 8, wherein the one or more driver trip preferences include a preferred refueling time limit.

13. The method of claim 8, wherein the one or more driver trip preferences include a preferred time near which to refuel.

14. The method of claim 8, wherein the one or more driver trip preferences include a preferred location near which to refuel.

15. The method of claim 1, wherein the using a VACS to select one or more recommended refueling points further comprises considering one or more travel-time adjusting factors.

16. The method of claim 15, wherein the one or more travel-time adjusting factors includes weather conditions along at least a portion of the route-to-be-traveled.

17. The method of claim 15, wherein the one or more travel-time adjusting factors includes traffic conditions along at least a portion of the route-to-be-traveled.

18. A computer-readable storage medium storing instructions that, when executed by a vehicle associated computing system (VACS), cause the VACS to perform the method comprising:
determining the reachability of one or more known refueling points along a route-to-be-traveled;
selecting one or more recommended refueling points, based at least in part on the determined reachability of the one or more known refueling points;
outputting at least a portion of the route-to-be-traveled including at least one recommended refueling point;
providing an option to route a vehicle to the recommended refueling point; and
responsive to a selection of an option to route the vehicle to the recommended refueling point, providing a route from a present destination to the recommended refueling point, wherein, when the recommended refueling point has been reached, the route reverts to the route-to-be-traveled.

19. A vehicle associated computing system (VACS) comprising:
a processor, operable to determine the reachability of one or more known refueling points along a route-to-be-traveled based on logic present in a memory associated with the VACS;
wherein the processor is operable to select one or more recommended refueling points, based at least in part on the determined reachability of the one or more known refueling points, based on logic present in the memory;
a display in communication with the processor, and operable to output at least a portion of the route-to-be-traveled including at least one recommended refueling point, based on instructions received from the processor;
wherein the display is further operable to provide an option to route a vehicle to the recommended refueling point, based on instructions received from the processor; and
wherein the processor, responsive to a selection of an option to route the vehicle to the recommended refueling point, is operable to provide a route from a present destination to the recommended refueling point, based on logic stored in the memory,
wherein, when the recommended refueling point has been reached, the processor is operable to revert the route to the route-to-be-traveled, based on logic stored in the memory.
